(19) United States
(12) Patent Application Publication
(10) Pub. No.: US 2012/0285000 A1
(43) Pub. Date: Nov. 15, 2012

(54) METHOD_OF_PRODUCING_A_VEHICLE_HEAT-INSULATING_WALL_AND_VEHICLE_HEAT-INSULATING_WALL.pdf

(76) Inventors: Michael Leibman, New York, NY (US); Yuri Levin, Weston, FL (US); Barry Milea, New York, NY (US)

(21) Appl. No.: 13/105,589

(22) Filed: May 11, 2011

(51) Int. Cl. B23P 17/00

(52) U.S. Cl. 29/527.1

(57) ABSTRACT

A method of producing a vehicle's heat-insulating wall is disclosed. The vehicle's interior lining is distinguished by structure comprising an outer wall, made from steel or aluminum, layer of a rigid grid having substantially uniform pattern of openings, made for instance from an expanded metal mounted over a plurality of supports spaced across the inner surface of the outer wall, layer of self-rising heat-insulating foam deposited between the inner surface of the outer wall and the rigid grid, and a decorative layer, preferably a polyurea resin. The provided grid is sufficiently rigid for withstanding without damage forces applied to it in the process of leveling excess of the deposited foam material having solidified after it had risen up through the openings of the grid.

### FIELD OF THE INVENTION

This invention relates to structures useful for thermal insulating a cold zone. In a particular aspect of this invention is concerned with the thermal insulation of vehicles for storing and transporting refrigerated articles. The invention further relates to a vehicle interior lining produced by the method according to the invention.

### BACKGROUND OF THE INVENTION

Refrigerated vehicles have long been in general use; however, because of the increasing consumption of frozen foods wider utilization of refrigerated vans is being experienced. Due to the storing of frozen foods for long periods of time during transportation, it is a necessity that the refrigerated vans be able to establish and maintain temperatures low enough to prevent thawing of the food which would result in deterioration unless consumed immediately.

Typically, the walls of a refrigerated van are constructed with a metallic outer skin such as aluminum or steel which provides some protection against physical deterioration and punctures by objects such as tree limbs. An inner skin of the wall may be comprised of metal like steel or aluminum or some other structural material such as plywood or plastic. The middle of the insulating wall is composed of a heat-insulating material such as high-density foam. Structural rigidity is provided by struts passing from the inner to the outer skin components. These struts can be composed of a metal but to avoid excessive conduction of heat in the refrigerated van the inner portion of the struts next to the inner skin of the wall could be made from heat-insulating material. However if struts are made completely out of metal some kind of heat-insulating material, for instance wood or plastic should be used to fabricate supports mounted between the outer skin or the struts and the inner skin.

Forming foam in place directly on structures is a labor consuming process due to difficulties in forming in situ foam layers of uniform density and thickness. Spraying self-rising foam directly on the structure tends to produce layer of very uneven thickness with a hard rind on the outside surface of the foam. Cutting the foam to a uniform thickness is a difficult and time consuming process. Applying foam within a closed space, for instance between both the solid outer and the solid inner skins of the wall to be insulated tends to produce structure of uneven density, and if the foam has no sufficient room to fully expand it may deform the outer and/or the inner skin of the wall.

Thus, there is a continuing need for improved method of fabricating high efficiency insulation coatings.

There is a solution for forming in situ low-density foam layers of uniform thickness described in prior art. For example, Krumweide U.S. Pat. No. 4,083,324 issued Apr. 11, 1978 presents an application of liquid, low-density foamable material to a surface through a flexible taut screen mounted on the supports. As the foam rises, it penetrates through the screen, leaving irregular projections above the screen. After the foam cures to at least a self-sustaining state, the screen is stripped away, leaving a uniform surface of the foam.

Unfortunately, approach described in the Krumweide patent can not be used for forming a uniform surface of a high-density foamable plastic material which is commonly used for vehicle wall insulation. The problem is that as soon as this material, usually in form of hot liquid mixture, has been applied to the inner surface of the wall and foamed up; it became solid in a matter of seconds. The foam get hard to such extend that it is necessary to use cutting, chiseling or grinding tool for removing its excess. It would be impossible to strip away the flexible screen as it is described in the prior art.

The high-density foam is brittle under the rind and has to be protected from direct hits after its rind is removed during the leveling process. For that reason the leveled surface of the foam usually get covered by some final protective layer, for instance plywood or elastomer, preferably a polyurea resin to protect the outer surface of the high-density foam from damages and to provide for smooth good looking finish.

### SUMMARY OF THE INVENTION

The present invention is directed to facilitate a vehicle's heat-insulating walls manufacturing method. The inventive vehicle's interior lining is distinguished by structure comprising an outer wall, usually made from steel or aluminum, layer of a rigid grid having substantially uniform pattern of openings, for instance made from an expanded metal, mounted over a plurality of supports spaced across the surface to be coated, layer of self-rising heat-insulating foam deposited between the outer wall and the rigid grid, and a decorative layer, preferably a polyurea resin.

It is an object of this invention to provide a simplified method of leveling self-rising foam material. After a liquid heat-insulating material being sprayed or poured on the inner surface of the outer skin of the wall to be insulated, an excess of the insulating material foams up through the openings of the rigid grid. This excess of the insulating material has to be removed for getting a leveled uniform surface. A rigidity of the grid provides resistance against forces applied to the grid in the process of removing, for instance by scraping off the foam's excess with the help of some sharp edge. In the process of scraping off sharp edges of the expanded metal and sharp edge of the scraping tool both are functioning as improvised scissors-acting cutting tool facilitating the removal of the foam's excess.

The above object, and others, is accomplished in accordance with this invention by manufacturing a heat-insulating wall with a build in rigid grid, preferably made from expanded metal which is mounted on a plurality of upstanding supports spaced across the inner surface of the heat-conducting outer skin of the wall to be insulated. The supports are made from a heat-insulating material, for instance from wood or plastic.

Another object of this invention is to provide a possibility for mounting inside the insulated compartment at any necessary spot of the wall a fastening hardware (for example rings, eyes, hooks, brackets etc.) useful for securing transported goods inside the vehicle. The rigid grid serves as a reliable mounting surface for them.

Yet another object of this invention is to provide a uniform surface of the high-density foam leveled with the outer surface of the expended metal.

And another object of this invention is to provide a protective decorative layer, for instance elastomer, preferably polyurea resin covering uniform surface comprising the outer surface of the grid and leveled surface of the high-density foam. The decorative layer also covers means for attaching fastening hardware to the grid.

### BRIEF DESCRIPTION OF THE DRAWINGS

Further features and advantages of the invention will be apparent from the following description and the drawings illustrating a preferred embodiment. In the drawings:

FIG. 1 shows a perspective view of the wall to be heat-insulated with supports, a rigid grid and one of the fastening rings being installed;

FIG. 2 shows a perspective view of the process of applying liquid foamable material through the openings of the rigid grid to the inside surface of the outer skin of the wall to be insulated;

FIG. 3 shows a perspective view of the process of leveling the solidified foam by chiseling off excess of it from the surface of the rigid grid; and

FIG. 4 shows a perspective view of the process of applying final decorative lining of the solidifying liquid polyurea on the uniform surface comprising the outer surface of the grid and leveled surface of the high-density foam.

### DETAILED DESCRIPTION OF THE INVENTION

The process of manufacturing a vehicle's heat-insulated compartment starts with construction of an additional wall dividing entire interior of the vehicle in two sections. This wall is separating a section intended for heat-insulated compartment from a front section of the track van occupied with seats for driver and passenger. The wall usually represents a wooden structure; it is not a subject of this invention and is not shown on the drawings.

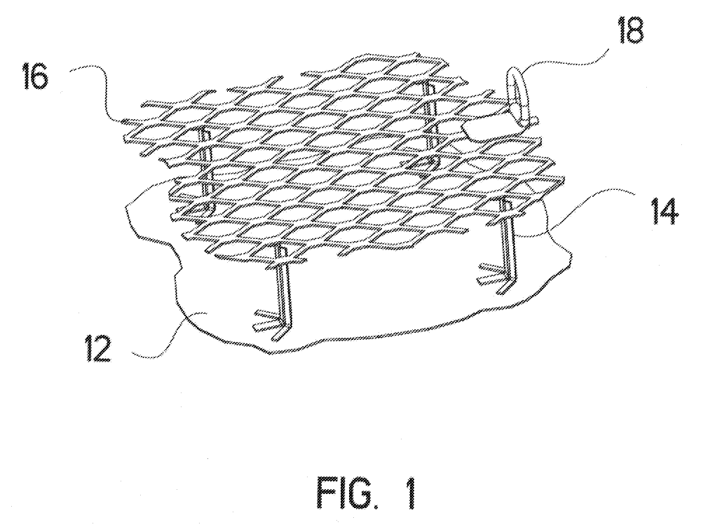

The process of manufacturing a vehicle's heat-insulating wall in one embodiment according to FIG. 1 starts with installation of made out of heat-insulating material supports 14 attached across the inner surface of the heat-conducting outer skin 12 of the compartment to be heat-insulated. There is no need to install supports 14 at the inner surface of the dividing wall (not shown) because it is usually made out of wood which itself is heat-insulating material.

Next step of the method of manufacturing the vehicle's heat-insulating wall in described embodiment is installation of a rigid grid made from expanded metal 16 over the supports 14 and over the dividing wall (not shown) of the vehicle's compartment to be heat-insulated. The means of fixing supports 14 to the inner surface of outer skin 12 and means of fixing expanded metal 16 to supports 14 and to the dividing wall (not shown) are not specified and are not shown on the drawing because they are well known devices and/or methods and are not subjects of this invention.

Further step of the method of manufacturing the vehicle's heat-insulating wall in described embodiment is mounting on expanded metal 16 the necessary auxiliary hardware, for instance, a plurality of metal rings 18 useful for securing articles transported in the vehicle. The means of fixing ring 18 to expanded metal 16 are not specified and are not shown on the drawing because they are well known devices and/or methods and are not subjects of this invention.

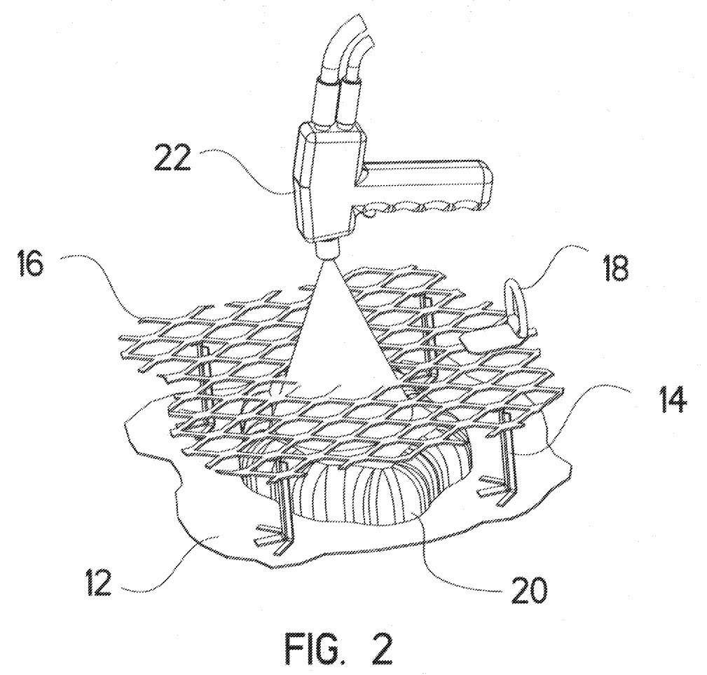

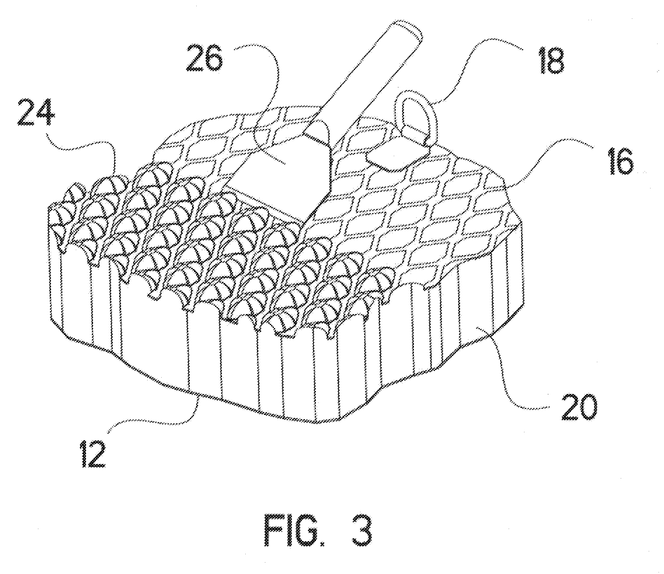

Yet another step of the method of manufacturing the vehicle's heat-insulating wall in described embodiment, shown on FIG. 2 is applying high-density foam 20 being in liquid, unexpanded state to the inside surface of outer skin 12 of the wall to be heat-insulated. It can be done according to FIG. 2 by using spray gun 22 for depositing foam 20 onto the inner surface of outer skin 12 through the openings of expanded metal 16. Spray gun 22 is adapted to be moved in uniform pattern across the inner surface of outer skin 12 for applying a uniform coating of foam 20 being in liquid state by projecting it against the inner surface of outer skin 12 through the openings of expanded metal 16. As soon as foam 20 get deposited onto the inner surface of outer skin 12 and onto an inner surface of the dividing wall (not shown), foam 20 expands foaming up in many places through the openings of expended metal 16 and creates protrusions 24 conditionally shown on FIG. 3. Foam 20 then solidifies in a matter of seconds.

Next step of the method of manufacturing the vehicle's heat-insulating wall in described embodiment is shown on FIG. 3. It is the process of leveling foam 20, for instance by using chisel 26 for cutting off a protrusion 24 of foam 20 from the surface of rigid layer of expanded metal 16. Rigidity of the expanded metal 16 provides support for chisel 26 in the process of removing protrusions 24. During chiseling off sharp edges of the openings of expanded metal 16 and sharp edge of chisel 26 both are functioning as improvised scissors-acting cutting tool facilitating the cutting process.

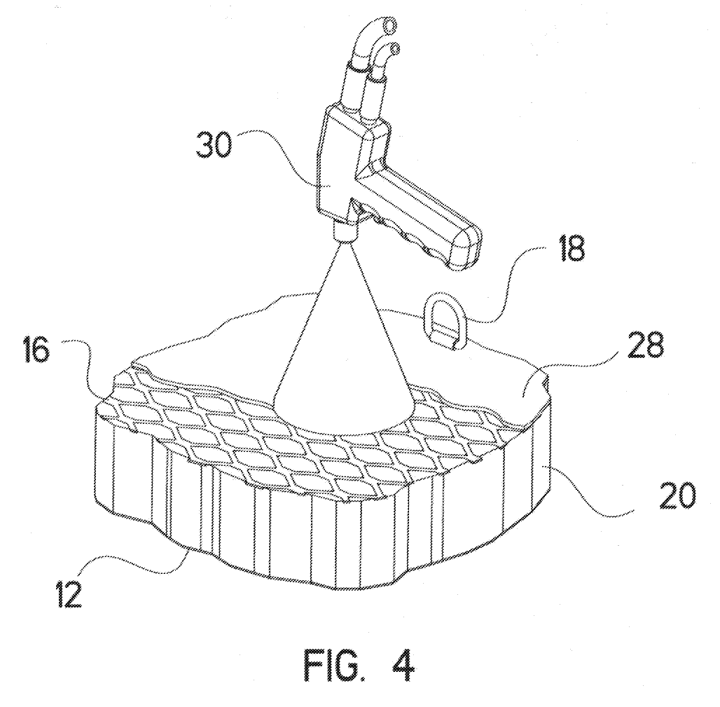

The last step of the method of manufacturing the vehicle's heat-insulating wall in described embodiment is shown on FIG. 4 which is a perspective view demonstrating the process of depositing final decorative lining, preferably liquid polyurea resin 28 onto the surface of foam 20 already leveled with outer surface of expanded metal 16. The process can be done according to FIG. 4 by using spray gun 30 for delivering liquid polyurea resin 28 to that surface. Spray gun 30 is adapted to be moved in uniform pattern across the leveled surface to apply a uniform coating of liquid polyurea resin 28 by projecting it against the leveled surface. Polyurea resin 28 get solidified after it is applied to the leveled surface comprising outer surface of expanded metal 16 and leveled outer surfaces of foam 20. The means (not shown) of fixing ring 18 to expanded metal 16 get embedded under decorative lining 28 rendered hidden.

It should be understood that various alternatives to the embodiment of the invention described herein may be employed in practicing the invention. It is intended that the following claims define the scope of the invention and that the method and apparatus within the scope of these claims and their equivalent be covered thereby.

1. A method of producing a vehicle heat-insulating wall, comprising;
installation a plurality of supports attached across an inner surface of an outer skin of a vehicle's wall to be heat-insulated;
installation a grid over said plurality of supports, said grid having substantially uniform pattern of openings;
depositing foam material in a liquid, unexpanded state through said grid onto said surface to form solid layer over said surface;
removing excess of said material from an outer surface of said grid providing a uniform surface comprises a leveled outer surface of said material and the outer surface of said grid; and
forming solid protecting and decorating layer over the uniform surface,
wherein said grid is provided sufficiently rigid for withstanding without damage forces applied to said grid in the process of removing excess of the foam material.

2. The method according to claim 1, wherein said means for depositing foam material comprise at least one spray gun adapted to be moved in uniform pattern across said uniform surface to apply a coating of foamable liquid by projecting said liquid against said surface through said grid.

3. The method according to claim 1, wherein the protecting and decorating layer is produced by depositing a polyurea resin in liquid state onto said uniform surface to form solid layer over that surface.

4. The method according to claim 1, wherein said means for depositing said resin comprise at least one spray gun adapted to be moved in uniform pattern across said uniform surface to apply a coating of said resin by projecting said resin in liquid state against said uniform surface.

5. The method according to claim 1, further comprising embedding at least one fastening member in the protecting and decorating layer during depositing said layer.
